(19) United States
(12) Patent Application Publication
(10) Pub. No.: US 2015/0251794 A1
(43) Pub. Date: Sep. 10, 2015

(54) EXTRUSION-BLOW-MOLDED PLASTIC CONTAINER WITH UNDERCUT NECK AND METHOD FOR ITS PRODUCTION

(71) Applicant: ALPLA WERKE ALWIN LEHNER GMBH & CO. KG, Hard (AT)

(72) Inventors: Johann KUENZ, Hard (AT); Herbert WOHLGENANNT, Schaffhausen (CH)

(73) Assignee: ALPLA WERKE ALWIN LEHNER GMBH & CO. KG, Hard (AT)

(21) Appl. No.: 14/722,680

(22) Filed: May 27, 2015

Related U.S. Application Data
(63) Continuation of application No. PCT/EP2013/003525, filed on Nov. 22, 2013.

(30) Foreign Application Priority Data
Nov. 27, 2012 (CH) 2557/12

(51) Int. Cl. B65D 1/02; B29C 49/04; B29D 22/00; B65D 1/40

(52) U.S. Cl. CPC B65D 1/0246; B65D 1/40; B29C 49/04; B29D 22/003; B29L 2031/7158

(57) ABSTRACT

An extrusion-blow-molded plastic container has a container body closed with a bottom and a neck with a pour opening. An inside wall of the container neck has at least one calibrated structuring, extending at least in places over a periphery of the inside wall. The calibrated structuring is limited in the direction of the container body by a material accumulation shaped as a collar extending at least partially along the periphery of the inside wall and essentially crosswise to a center axis of the neck.

### RELATED APPLICATION(S)

This application claims priority as a continuation application under 35 U.S.C. §120 to PCT/EP2013/003525, which was filed as an International Application on Nov. 22, 2013 designating the U.S., and which claims priority to Swiss Application Nos. 2557/12 filed in Switzerland on Nov. 27, 2012 and 2631/12 filed in Switzerland on Nov. 30, 2012. The entire contents of these applications are hereby incorporated by reference in their entireties.

### FIELD

The disclosure relates to an extrusion-blow-molded plastic container and to a method for the production of such a plastic container.

### BACKGROUND INFORMATION

Containers made of tin or multicolored sheet metal, glass or ceramic, common in the past, are increasingly being replaced by containers made of plastic. In the meantime, primarily plastic containers can be used for the packaging of fluid substances, for example beverages, household products, care products, cosmetics, etc. The low weight and the lower costs can play a significant role in this substitution. The use of recyclable plastic materials and the overall advantageous total energy balance in their production also contribute to promoting the acceptance of plastic containers, such as plastic bottles, by consumers.

The production of plastic containers, such as plastic bottles, for example made of polyethylene or polypropylene, has been carried out in an extrusion-blow-molding method, such as in a film bubble method. In this case, a plastic hose can be extruded continuously or intermittently with an extrusion head, introduced into the mold cavity of a blow mold tool, inflated by overpressure, cooled and demolded. The inflation of a plastic hose section that is introduced into the blow mold cavity can be carried out with a calibrating blow pin, which is run into the plastic hose section that is to be inflated through an opening of the blow mold cavity. On the one hand, the calibrating blow pin can have the object of introducing air into the plastic hose, so that the latter is formed in the shape of the blow mold cavity. On the other hand, the calibrating blow pin can also be used for defined inside forming (calibration) of the neck of the plastic container that is inflated from the hose section and in which the pour opening is provided. To this end, the calibrating blow pin is run into the hose section through the opening of the closed blow mold tool. In this case, excess plastic material is axially displaced, and the inside diameter of the neck, which can have a cylindrical inside wall, with the pour opening can be determined.

Known plastic containers that are produced in the extrusion-blow-molding method have a seal that is snugly secured to fasteners that are formed on the outside wall of the container neck. The fasteners can be designed, for example, as an outside threading, as outside threaded sections, as guiding structures of a bayonet closure, or as a snap ring. In this case, the fasteners can be designed relative to the outside wall of the container neck in a projecting manner or as corresponding grooves and recesses in the outside wall of the container. The fasteners can also be designed as a combination of projections and recesses. The seal is equipped with correspondingly designed elements in order to make possible a positive interaction.

Known seals can extend above and project over the neck of the plastic container. As a result, the plastic container that is equipped with the seal can have a greater structural height than the plastic container by itself. Also, the plastic containers that are equipped with a seal can have a clearly visible separating line between the seal and the plastic container, which, however, can be undesirable. In many cases, the seals also come in different colors than the plastic container. If, however, it is desired that the seal and the plastic container form a unit in color, issues can arise just from the fact that, there can be different materials for the plastic container, on the one hand, and for the seal, on the other hand. The shades of color of the plastic container and the seal may not match exactly. Only in the case of a largely identical color shade can the surface conditions of the seal and the plastic container, different in many cases, lead to different color perceptions by the observer. The different surface conditions can be a result of the different materials but also the different production methods. For example, the plastic container that is produced in an extrusion blow-molding method can have a gleaming surface, while the seal that is produced in many cases in an injection-molding method can have a matte surface. Thus, plastic containers and/or seals originating from different production batches can have slightly different shades of color. At times, this is unacceptable to the consumers of the containers with seals. The visible separating line and the differences in color between the seal and the plastic container can therefore also adversely affect structural freedoms with respect to the container design. The greater structural height of the container provided with the seal increases the space requirement.

### SUMMARY

An extrusion-blow-molded plastic container is disclosed, comprising: a container body closed with a container bottom, and a container neck connected to the container body, the container neck having a pour opening, wherein an inside wall of the container neck includes at least one calibrated structuring extending over a periphery of the inside wall at least in places, wherein the calibrated structuring is limited in a direction of the container body by a material accumulation, the material accumulation being shaped as a collar that extends at least partially along the periphery of the inside wall and crosswise to a center axis of the container neck.

A method is disclosed for the production of a plastic container having a container body closed with a container bottom, and a container neck connected to the container body, the container neck having a pour opening, wherein an inside wall of the container neck includes at least one calibrated structuring extending over a periphery of the inside wall at least in places, wherein the calibrated structuring is limited in a direction of the container body by a material accumulation, the material accumulation being shaped as a collar that extends at least partially along the periphery of the inside wall and crosswise to a center axis of the container neck, the method comprising: extruding continuously or intermittently by an extrusion head in an extrusion-blow-molding method, a section of a single-layer or multi-layer plastic hose; introducing the section of a single-layer or multi-layer plastic hose into a mold cavity of a blow mold tool; inflating and cooling the section of the single-layer or multi-layer plastic hose by introducing via a calibrating blow pin that is run into the hose through an opening in the blow mold tool, a gas that is injected with overpressure into the mold cavity to form the plastic container, wherein when the calibrating blow pin is run in, plastic material is displaced from a lost section of the plastic hose, upstream from the container neck through the pour opening in the container neck, and in the inside wall of the container neck, the at least one calibrated structuring is designed in the shape of an outside contour of a calibrating section of the calibrating blow pin; forming the material accumulation that limits the calibrated structuring in the direction of the container body from the plastic material; calibrating a section of the plastic hose that corresponds to the container neck; and demolding the plastic container.

### BRIEF DESCRIPTION OF THE DRAWINGS

Additional advantages and features of the disclosure arise from the subsequent description of the method with reference to the diagrammatic drawings in depictions that are not to scale, wherein:

FIG. 1 shows a depiction, axially cut on half a side, of a calibrating blow pin that is run into a blow mold tool according to an exemplary embodiment of the disclosure;

FIG. 2 shows an axially cut depiction of a container neck with a tip seal that is designed like a plate in the closed position according to an exemplary embodiment of the disclosure;

FIG. 3 shows the plate-like tip seal from FIG. 2 in the open position;

FIG. 4 shows a calibrating blow pin according to an exemplary embodiment of the disclosure that is run into a blow mold tool in a depiction analogous to FIG. 1;

FIG. 5 shows another axially cut depiction of a container neck with a tip seal that is designed like a disk in an open position according to an exemplary embodiment of the disclosure; and

FIG. 6 shows the depiction, from FIG. 5, with a tip seal in a closed position.

In the subsequent description of the figures, the same reference numbers in each case refer to the same components.

### DETAILED DESCRIPTION

Exemplary embodiments of the disclosure can enhance known extrusion-blow-molded plastic containers. A plastic container can be modified to the extent that the mounting of a seal is made possible without a change or with only a slight change in the structural height of the plastic container. It can also be possible to avoid a separating line between the seal and the plastic container, as well as aesthetic color deviations between the plastic container and the seal. A plastic container as disclosed herein can be provided that can be produced without major method changes in the extrusion-blow-molding method. In this case, it is possible to keep the production cycles largely unchanged.

An extrusion-blow-molded plastic container, which can have a container body that is closed with a container bottom and a container neck that connects to the container body and that is equipped with a pour opening, is provided by exemplary embodiments of the disclosure. An inside wall of the container neck can have at least one calibrated structuring, which extends at least in places over a periphery of the inside wall. The calibrated structuring is limited by a material accumulation in the direction of the container body. The material accumulation is shaped as an at least partial collar that extends along the periphery of the inside wall and essentially crosswise to a center axis of the container neck.

Calibrated can be defined as the structuring that can be manufactured in a reproducible manner with predetermined amounts. The tolerances of the mass of the calibrated structuring can, depending on the materials, be within the customary tolerances that can be achieved in the extrusion-blow-molding method. Because, for forming the calibrated structuring, additional plastic material from the lost hose section that is adjacent to the pour opening is introduced through the pour opening into the container neck, the tolerances can be produced by, for example, cooling processes and/or creep processes of the plastic. The excess plastic material that is not required for the forming of the calibrated structuring limits the calibrated structuring as material accumulation, which is shaped as a collar. The collar extends in the direction toward the center axis of the container neck; i.e., into the interior of the container neck. An opening that is limited by the collar can be in general smaller than the pour opening. In this connection, the calibrated structuring as well as the collar are formed in one piece with the container neck.

Also, for forming the calibrated structuring, a calibrating tool is required, whereby the shape of the structuring can be determined by the tool. For example, the calibrating tool is integrated as a calibrating section on the calibrating blow pin, which is run into a plastic hose section that is inserted into a mold cavity. A calibrated structuring can be defined as a structural element that is designed in a positive or negative fashion on or in the inside wall of the container neck and can prevent that the calibrating tool from being removed from the mold cavity in the opposite direction of movement. The calibrated structuring can thus be designed as a projection or as an undercut relative to the inside wall of the container neck. An undercut turns in by a predetermined amount relative to the unstructured course of the inside wall of the container neck, whereby this amount can be greater than or equal, for example, to 0.25 mm. When the calibrated structuring is designed as a projection, it turns out by a predetermined amount relative to the unstructured course of the inside wall in the direction of a center axis of the container neck, whereby the predetermined amount can be greater than or equal to 0.25 mm. The predetermined amount can be greater than 0.5 mm, for example greater than 0.7 mm, based on the neck diameter.

In general, the calibrating blow pin or the calibrating tool can be run into the mold cavity by an exclusively translatory movement. An exclusively translatory removal of the calibrating blow pin from the mold cavity can be prevented by the calibrated structuring. Nevertheless, to make possible a removal of the calibrating blow pin or a calibrating tool, it may be necessary, for example, to remove the calibrating blow pin or the calibrating tool from the plastic container by a combination of the translatory and rotational movements. In an alternative method variant, the calibrating blow pin or the calibrating tool together with the plastic container connected to it, can be demolded from the mold cavity and is then pulled off from the calibrating blow pin or the calibrating tool with use of the elasticity of the plastic of the plastic container. In this exemplary embodiment according to the disclosure, the calibrating tool, or the calibrating blow pin, is immovable or rigid relative to its outer shape. Also, the calibrating tool or the calibrating section of the calibrating blow pin can be designed to be changeable in its shape in order to be able to remove the calibrating tool or the calibrating blow pin from the plastic container after the calibrated structuring is formed.

By the plastic container on the inside wall of the container neck having at least one calibrated structuring, the specification for the mounting of an inside seal can be met. In this case, the calibrated structuring that is circumferential, at least in places, can have a depth that is sufficient to occupy the inside seal and also to be held securely in the usual drop tests. Because of the possibility of attaching an inside seal, the structural height of the plastic container equipped with the seal itself can remain essentially limited to the height of the container. The space requirement for the container that is equipped with seals is thus reduced. The inside seal contributes only insignificantly or not at all to the overall structural height and is virtually invisible in its side view. As a result, the separating line between the seal and the container that is usually clearly visible can be omitted in the case of plastic containers with seals. Differences in color caused by different shades of color or by different surface conditions can play virtually no role because of the seal that is invisible in the side view. As a result, the expense for the color matching of the plastic container and the seal can be reduced. Also, the seal can be as a point design element, i.e., matched in color relative to the plastic container, in the overall appearance of the plastic packaging. In this connection, the plastic packaging in general includes the plastic container, the seal, and a label.

In exemplary embodiments of the disclosure, the described types of closures can be tip seals, which, when they are flush with the pour opening, can prevent a removal of the substance stored in the plastic container. In this connection, a center axis of the seal and the center axis of the container neck are in general parallel in a closed position. In order to make possible a removal of the stored substance, the tip seal is moved into an open position in general by the center axis of the tip seal being inclined relative to the center axis of the container neck and correspondingly the two center axes encompassing an acute angle. In an advantageous way, a top of the collar, facing the pour opening and which is formed from the material excess, can be calibrated. Thus, this calibrated top can form a defined bearing surface for the seal, in general produced in injection-molding, for its closed position and its open position. A form corresponding to the top of the collar can be designed in the calibrating blow pin or the calibrating tool. When the hose in the tool is pressed by the gas pressure on the inside wall of the mold halves, this pressure can also be used to press the material accumulation on the form, corresponding to the top, in the calibrating tool in order to form the calibrated top of the collar. Accordingly, the collar can be unstructured on a bottom that faces away from the pour opening in the sense that the mold of the bottom is formed by the gas pressure.

In exemplary embodiments, the plastic container should not be configured in such a way that an axis of the container body and the center axis of the container neck are identical or extend parallel to one another. Rather, the center axis of the container body and the center axis of the container neck can encompass an acute angle with one another, which can be, for example, up to 10°, up to 20°, and up to 25°. Even the creation of an acute angle of up to, for example, approximately 45° is possible by suitable manufacturing methods. In such an arrangement, a visible top of the inside seal can be used as a bearer of a logo.

A contour of the inside wall and a contour of the outside wall of the container neck of the extrusion-blow-molded plastic container are not designed in a manner corresponding to one another. In this connection, the contour of the inside wall can be different from the contour of the outside wall. For example, the inside wall can have an inside threading, and the outside wall can be designed as a circular cylinder with a flat; i.e., essentially unstructured, shell without shrink marks. Also, the outside wall can be designed in a bomb-shaped manner, and the inside wall can have at least one undercut for receiving the seal.

The at least one calibrated structuring on the inside wall of the container neck can be designed in a different manner and thus can also allow the mounting of different types of inside seals. The calibrated structuring can be configured in such a way that the seal is sealed off at any position along the container neck. In an exemplary embodiment of the disclosure, the extrusion-blow-molded plastic container in the inside wall of its container neck can have a single, annular circumferential undercut, which extends over, for example, ⅗ to 8/9 of the axial length of the container neck. The depth of the undercut relative to the inside wall is dependent upon the cross-section of the container neck and the requirements of a drop test from a predetermined height, which the closed plastic container should withstand without damage. The calibrated structuring can be designed in such a way that the mounting of a tip seal that is designed like a disk is made possible. The predetermined amount, by which the calibrated structuring projects or recedes relative to the inside wall of the container neck, can be, for example, up to approximately 1.6 mm per side or more based on the container neck diameter, container size, and material. It is shown, however, that in the case of a container neck with a diameter of 38 mm, an article volume of approximately 400 ml and a drop height of 120 cm in connection with a disk-like seal and when using a typical HDPE material, a size of 0.72 mm can be adequate for the calibrated structuring.

The contour of the calibrated structure of the inside wall of the container neck of the extrusion-blow-molded plastic container is matched to the side contour of the tip seal that is designed like a disk. For example, the calibrated structuring can have a contour that resembles a section of a torus surface. This means that the axial radius of curvature and the radial radius of curvature are different from one another. The torus surface can be formed on an undercut of the inside wall or on a projection relative to the inside wall. In an exemplary embodiment of a plastic container of the disclosure, which may prove suitable in particular for a larger opening diameter, the calibrated structuring of the container neck can have a contour that resembles a section of a spherical surface. This can mean that the axial radius of curvature and the radial radius of curvature are the same size. A tip seal that is suitable for this exemplary embodiment then corresponds to a disk that is cut from a sphere. Also, here, the calibrated structuring can be designed as an undercut or as a projection, in each case with a contour like a spherical surface.

The calibrated structuring of the inside wall of the container neck of the extrusion-blow-molded plastic container can turn into an at least partially circumferential collar at its outlet that faces the container body, which collar can have a radial protrusion relative to the inside wall. The at least partially circumferential collar can be used as a seating or support for the tip seal that is designed like a disk. The collar can also be shaped as an annular shoulder. So that tiltability is ensured, the tip seal that is designed like a disk can have a seating surface that runs approximately over half of its periphery approximately parallel to a top surface of the tip seal and, starting at approximately the halfway point, obliquely to the top surface. In an exemplary embodiment of a extrusion-blow-molded plastic container of the disclosure, the annular, at least partially circumferential, shoulder forms a seating surface, whereby the seating surface and a center axis of the container neck encompass an acute angle. In this exemplary embodiment of the container neck, the disk-like tip seal can be designed in a cylindrical manner. So that its orientation that is approximately perpendicular to the container axis can be ensured, another two seating projections that can be diametrically opposite to one another and that engage in lateral recesses or indentations in the seating surface of the disk-like tip seal can be provided in the inside wall of the container neck.

In addition, the container neck and the seal can be configured in such a way that even in the open position, the seal can be sealed off at predetermined spots within the container neck, so that the container contents can leave the plastic container only at a predetermined spot.

The radial protrusion of the at least partially circumferential annular shoulder relative to the inside wall of the container neck is, for example, approximately 0.5 mm to 2.5 mm depending on the container size.

In another exemplary embodiment of a extrusion-blow-molded plastic container according to the disclosure, the at least one calibrated structuring of the inside wall of the container neck can be designed as at least one receiving groove for a bayonet closure. Because of the better attachment of a seal, two or more receiving grooves that are distributed over the periphery of the inside wall can be formed for a bayonet closure in the inside wall of the container neck.

Another exemplary embodiment of the extrusion-blow-molded plastic container according to the disclosure can have a container neck, in which the at least one calibrated structuring of the inside wall of the container neck can be designed as an inside threading. Threaded seals are sufficiently well known. The positive fit, extending over a relatively large periphery, between the threaded passages of the inside threading that interact with one another in the container neck and the outside threading on a rotary closure make possible a reliable hold that can ensure the fulfillment of the required drop test. The calibrated structuring for the inside threading can be made using the calibrating blow pin. The demolding of the calibrating blow pin is usually done by traction. Should the elasticity of the material that is used for the plastic container be too low for traction demolding, the calibrating blow pin can also be twisted out to demold it.

At the transition from the container neck of the extrusion-blow-molded plastic container to the container body, a groove that is circumferential at least in places can be arranged in an outside wall of the container neck. At the transition from the container neck to the container body, a constriction of the wall thickness, which limits a displacement of the plastic material in the subsequent container body during calibration of the container neck and in the forming of the at least one undercut, is produced by the groove.

For the production of a plastic container with a container neck that is designed according to exemplary embodiments of the disclosure, a section of a single-layer or multi-layer plastic hose that is extruded continuously or intermittently by an extrusion head is introduced into a mold cavity of a blow mold tool. The hose section that is located in the mold cavity is inflated and cooled by a calibrating blow pin that is run into the hose through an opening in the blow mold tool by a gas that is injected with overpressure in the shape of the mold cavity to form the plastic container. In this case, a section of the plastic hose that corresponds to the container neck is calibrated. When the calibrating blow pin is run into the hose section, plastic material is displaced from a lost section, upstream from the container neck that is created, of the plastic hose in the container neck. In an inside wall of the container neck, at least one calibrated structuring is shaped by the run-in calibrating blow pin, the shape of which structuring is determined by an outside contour of a calibrating section of the calibrating blow pin. The calibrated structuring can be designed as an undercut or as a projection. The finish-formed plastic container is ultimately demolded.

So that at least one calibrated structuring can be created in or on the inside wall of the container neck, the calibrating blow pin should have a calibrating section, which can have, for example, an excess compared to a diameter of a cylindrical inside section of the container neck. Plastic material is displaced from the container neck into the container body because of this area of the calibrating blow pin that is larger in diameter. In addition to a circular contour, the inside wall of the container neck can also be shaped with an oval or rectangular contour or a combination of round and rectangular, whereby the described process can be applied analogously. So that enough plastic material is now left in the container neck to ensure the required minimum wall thicknesses, when the calibrating blow pin is run into the hose section that is located in the mold cavity, plastic material is displaced from a lost section, upstream from the container neck, of the extruded plastic hose in the container neck. The plastic material that originates from the lost section, which is also referred to many times as neck cores, compensates for the plastic material that is displaced from the neck section. Thus, sufficient material is once again available, and the required minimum wall thicknesses in the container neck can be maintained. The lost section of the extruded plastic hose can be automatically separated from the container neck at the end of the blow-molding/calibrating process. By plastic material being displaced from the lost section in the container neck with the running-in of the calibrating blow pin, the inside wall of the container neck can be equipped for the first time with one or more calibrated structuring, which are designed in such a way that, for example, the mounting of an inside seal is made possible.

In an exemplary embodiment of the disclosure, a groove that is circumferential, at least in places, can be molded-on at a transition from the container neck to the container body in an outside wall of the plastic container. Owing to this groove, a constriction of the wall thickness can be created at the transition from the container neck to the container body. This constriction limits the displacement of the plastic material into the connecting container body during calibration of the container neck and in the forming of the at least one structuring. By the constriction being selected in such a way that less plastic material can be displaced from the container neck into the container body, as a readjustment of the lost section of the plastic hose in the container neck is made simultaneously, more complex structuring, such as, for example, threaded passages arranged behind one another, can also be created in the inside wall of the container neck by an exclusively translatory movement of the calibrating blow pin with the integrated calibrating section. Because the displacement of the plastic material through the constriction is impeded, the latter is briefly locally compressed in order to expand again in the empty spaces that are located between the areas of the calibrating section that are larger in diameter.

In an exemplary embodiment of the disclosure, an at least partially circumferential annular shoulder can be designed at a transition from the container neck to the container body, for example at a transition from the calibrated structuring to the container body, which shoulder can have a radial protrusion relative to the inside wall of the container neck. The at least partially circumferential annular shoulder can be preferably designed with a radial protrusion of, for example, approximately 0.5 mm to 2.5 mm. When mounting a tip seal that is designed like a disk, it can be used as a seating surface or as a support. So that the tiltability is ensured, the tip seal that is designed like a disk is shaped with a seating surface that extends approximately over half its periphery essentially parallel to a top surface of the tip seal and approximately starting at the halfway point, obliquely to the top surface.

In an exemplary method according to the disclosure, that the annular shoulder that is at least partially circumferential is designed in such a way that the shoulder and a center axis of the container neck encompass an acute angle. The disk-like tip seal can now be designed cylindrically. Of course, the outside contour of the tip seal can have any outside contour. It can be designed, for example, to be oval, triangular, square, or polygonal. So that its orientation that is approximately perpendicular to the container axis can be ensured, two seating projections that are, for example, diametrically opposite to one another can further be designed in the inside wall of the container neck, which projections engage in lateral recesses or indentations in the seating surface of the disk-like tip seal.

The contour of the calibrated structuring of the inside wall of the container neck of the extrusion-blow-molded plastic container can be matched to the side contour of the tip seal that is designed like a disk during the calibration. For example, the calibrated structuring of the container neck can be designed with a contour that resembles a section of a torus surface. This means that the axial radius of curvature and the radial radius of curvature of the structuring are different from one another. In an exemplary embodiment according to the disclosure, the calibrated structuring of the inside surface of the container neck can be equipped with a contour that resembles a section of a spherical surface. This means that the axial radius of curvature and the radial radius of curvature are the same size. A tip seal that is suitable for this exemplary embodiment then corresponds to a disk that is cut from a sphere. Also, a contour of the inside wall and a contour of an outside wall that is opposite to the inside wall are not designed in a corresponding manner to one another, so that, for example, the outside contour is flat, and the inside contour can have at least one calibrated structuring.

In an exemplary method according to the disclosure, the inside surface of the container neck can be equipped with one or more receiving grooves for a bayonet closure. Ultimately, an inside threading can also be made in the inside wall of the container neck.

In this connection, it is clear to those skilled in the art that the individual features, if they are not mutually exclusive, can be combined with one another in any way in order also to arrive at other configurations of the disclosure.

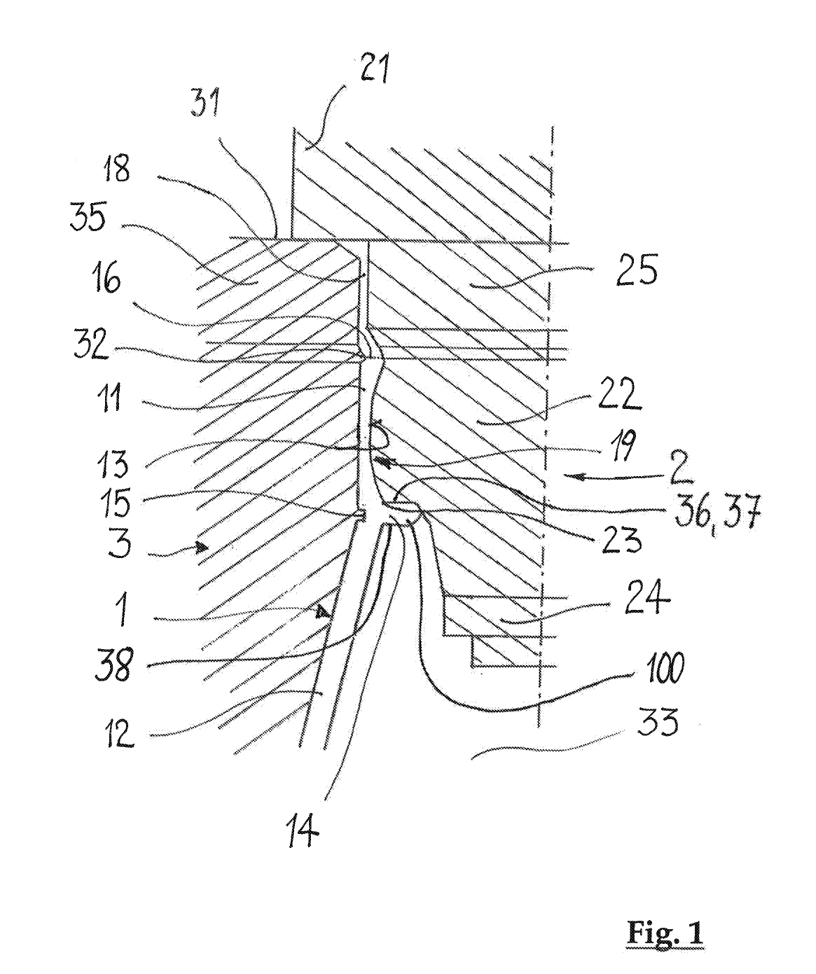

FIG. 1 shows an axial section of a half side of a calibrating blow pin that is run into a mold cavity of a blow mold tool for the production of a plastic container, which bears overall the reference number 2. The blow mold tool, of which only one upper section, designed in particular for shaping a container neck, is depicted, bears the reference number 3. The mold cavity is provided with the reference number 33. In the intermediate space between the calibrating blow pin 2 and the blow mold tool 3, a container neck 11 of a plastic container provided with the reference number 1 is indicated. A container body 12 connects to the container neck 11. For the sake of better clarity, hatching of the cutaway container neck 11 or the container body 12 is not shown.

FIG. 1 shows the calibrating blow pin 2 in its end position, in which a stop 21 of the calibrating blow pin 2 rests on a support 31 of the blow mold tool 3. Owing to the stop 21 and the support 31, it is ensured in a simple mechanical way that the calibrating blow pin 2 is always run into the mold cavity 33 with the same width. The calibrating blow pin 2 can have a calibrating section 22 whose outside contour is designed curved approximately like a spherical surface in the depicted embodiment. Instead of a spherical surface form, the calibrating section 22 could also have the form of a torus surface. A nozzle part 24 connects to the calibrating section 22, via which a gas is injected with overpressure in order to inflate an extruded plastic hose section, located in the mold cavity 33, in the shape of the mold cavity 33 to form the plastic container 1. Between the stop 21 and the calibrating section 22, a resqueezing section 25 is arranged, whose function is explained in still more detail below.

The blow mold tool 3 can have an entrance section 35 that ends on an edge projection 32. This edge projection 32 is formed in the plastic container 1 as a tapering section. In a subsequent unit, the container neck 11 is then essentially separated from a section of the plastic hose 18, adjoining the container neck 11 and located above the neck edge 16, along its lowest tapering section, which later forms a neck edge 16 of the container neck 11 and is depicted here as a dotted line. This section of the plastic hose 18, which is located between the entrance section 35 of the blow mold tool 3 and the resqueezing section 25 of the calibrating blow pin 2, is referred to as a lost hose section or else as neck cores.

When running the calibrating blow pin 2 into the hose section surrounded by the blow mold tool 3, plastic material is displaced from the lost hose section 18 and the container neck 11 in the direction of the container body 12 from an edge 23, emerging from the calibrating section 22, and the calibrating section 22 itself. The displaced plastic material collects at the transition from the container neck 11 to the container body 12 and forms there an at least partially circumferential collar or an at least partially circumferential annular shoulder 14. The resqueezing section 25 of the calibrating blow pin 2 displaces additional plastic material from the lost hose section 18 in the neck section 11, so that a calibrated structuring is formed on its inside wall 13 in the shape of the outside contour of the calibrating section 22, and said structuring is designed as an undercut 19 according to the depicted embodiment. The calibrated undercut 19 designed in the inside wall 13 can have, for example, a contour like a spherical surface or a contour like a torus surface.

To support the forming of the at least partially circumferential annular shoulder 14, a circumferential groove 15 that is annular at least in places can be molded-on in an outside wall of the container neck 11, opposite to the inside wall, at the transition to the container body 12, whereby a residual part of the outside wall is designed as a flat, straight circular cylinder, i.e., without shrink marks. Thus, a contour of the outside wall is different from a contour of the inside wall 13 in such a way that these two contours do not correspond to one another. At the transition from the container neck 11 to the container body 12, the groove 15 creates a wall thickness constriction, which offers resistance in the displacement of the plastic material from the container neck 11 into the container body 12. As a result, the forming of the at least partially circumferential annular shoulder 14 as well as the forming of the calibrated undercut 19 can be promoted. The calibrated structuring in the form of an undercut 19 is limited by the annular shoulder 14.

The annular shoulder 14 is formed from the plastic that was displaced from the section of the plastic hose 18, located above the neck edge 16, by a pour opening on the neck edge 16 in the container neck 11 and is excess according to the configuration of the calibrated structuring 19. The excess plastic forms a material accumulation 100, which is deformed by the gas pressure that is required for inflating the hose section that is inserted into the blow mold tool 3. In this connection, a calibrated top 36 that faces the pour opening is formed on the annular shoulder 14, which corresponds to a corresponding form 37 that is made in the calibrating section 22 and that is configured here like a disk. This calibrated top 36 can be used as a stop for all types of seals. A bottom 38 opposite to the top 36 and facing away from the pour opening is formed in this embodiment by the gas pressure and is thus unstructured.

The calibrated structuring, created in the inside wall 13 of the container neck 11, in the form of an undercut 19 can have a depth that is greater than or equal to 0.25 mm relative to an unstructured contour of the inside wall 13. In a suitable configuration, the undercut 19 extends over approximately ⅗ to approximately 8/9 of the axial length of the container neck 11. Depending on the size of the container neck or the container neck diameter, its depth can be greater than approximately 0.5 mm, for example greater than approximately 0.7 mm. In the selection of the depth of the undercut or in the selection of the height of a calibrated structuring that is designed as a projection, the size of the container neck 11, as well as relevant customer specifications, such as, for example, the drop height, the material selection, etc., are to be taken into consideration. The at least partially circumferential annular shoulder 14, which also can be designed as a closed ring, shows a radial protrusion of, for example, approximately 0.5 mm to approximately 2.5 mm relative to the inside wall 13 of the container neck 11. The container neck 11 that is designed in such a way is prepared for receiving an inside seal, which can be designed as a plate-like tip seal.

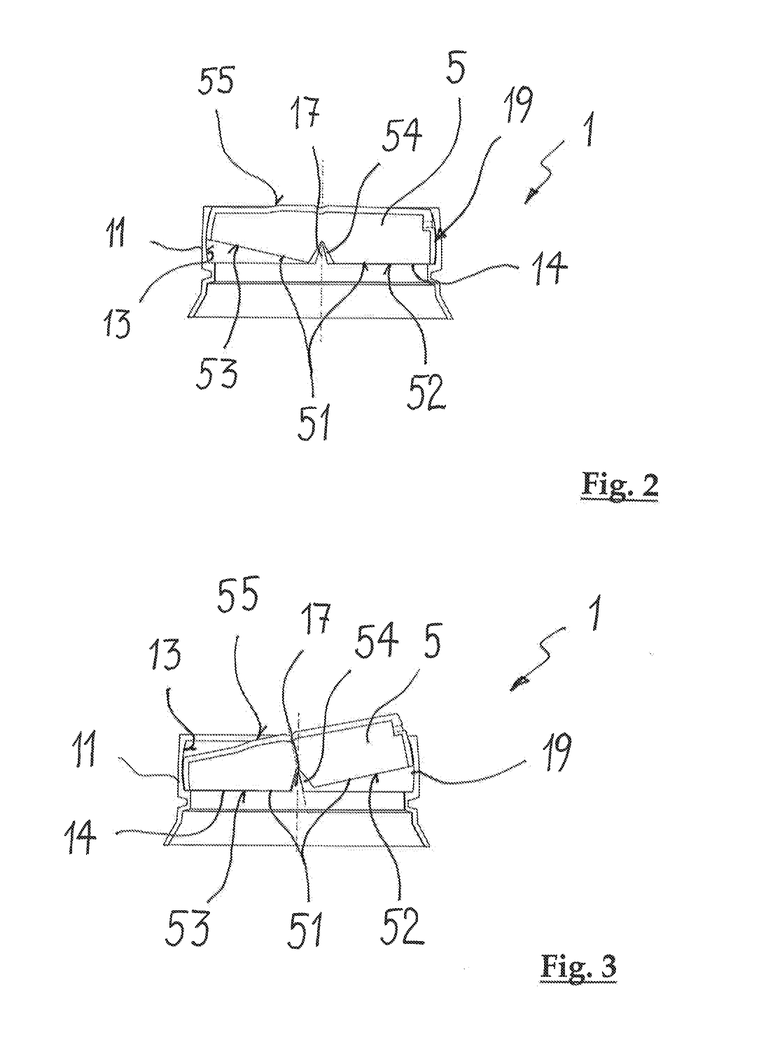

FIGS. 2 and 3 show a plate-like tip seal 5, mounted in the container neck 11, in the closed position (FIG. 2) and in the open position (FIG. 3). The plate-like tip seal 5 can have a seating surface 51 with a first seating section 52, which runs approximately over half of its peripheral extension approximately parallel to a top surface 55 of the tip seal 5. A subsequent second seating section 53 extends obliquely inclined to the top surface 55. The plate-like tip seal 5 is supported on the annular circumferential shoulder 14. In the closed position, its first seating section 52 that extends parallel to the top surface 55 rests on the annular circumferential shoulder 14 (FIG. 2). In the open position, the obliquely extending second seating section 53 rests on the annular circumferential shoulder 14 (FIG. 3). On the inside wall 13 of the container neck 11, two calibrated undercuts 19 that are for example, diametrically opposite to one another, can also be designed as seating projections 17, which engage in lateral recesses 54 or indentations in the seating surface 51 of the plate-like or disk-like tip seal 5. The contour of the undercut 19, designed in the inside wall 13, of the container neck 11 of the extrusion-blow-molded plastic container 1 is matched during the calibration to the side contour of the tip seal 5 that is designed like a disk.

In an exemplary embodiment of the container neck 11, according to the disclosure, the annular circumferential shoulder 14, which forms a seating surface for the seal, can also be designed in such a way that the seating surface and a center axis of the container neck encompass an acute angle. In such a design of the container neck 11, the plate-like tip seal 5 can have an overall cylindrical shape with a seating surface that extends essentially parallel to the top surface 55. The tiltability of the plate-like seal 5 can be ensured by the tilted design of the annular circumferential shoulder 14. So that the plate-like tip seal 5 in the closed position is oriented approximately perpendicular to the container axis, two seating projections 17 that are for example, diametrically opposite to one another, can also be designed in the inside wall 13 of the container neck 11, which projections engage in lateral recesses or indentations 54 in the seating surface of the disk-like tip seal 5.

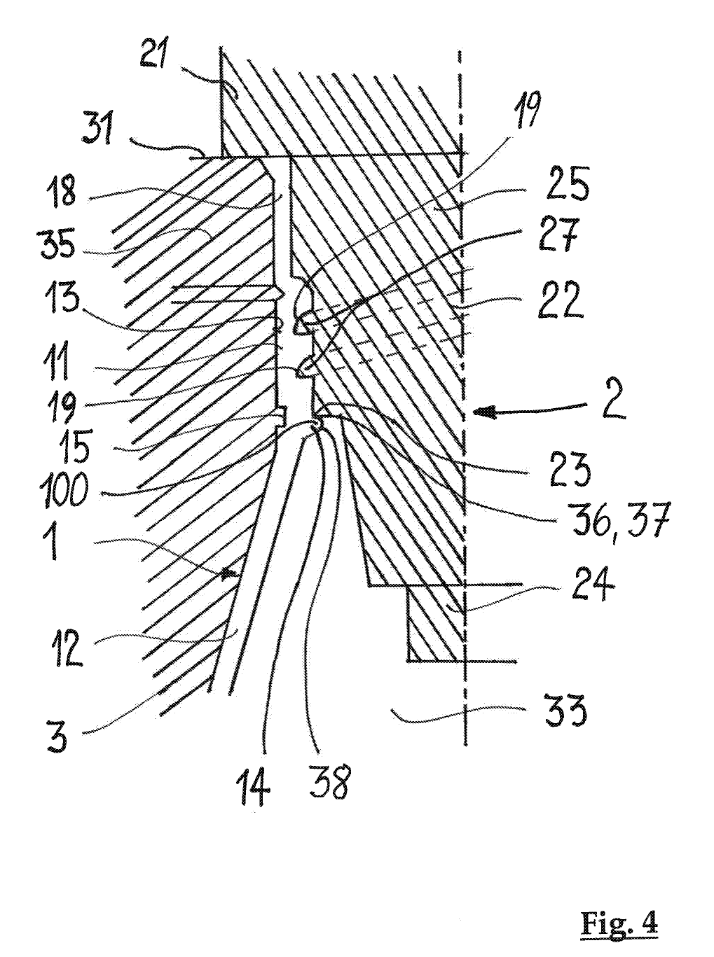

FIG. 4 shows a variant of a calibrating blow pin, which in turn bears the reference number 2 overall, in a depiction analogous to FIG. 1. The same parts therefore bear the same reference numbers as in FIG. 1. Unlike the embodiment explained based on FIG. 1, the calibrating section 22 of the calibrating blow pin 2 can have threaded projections 27. The threaded projections 27 of the calibrating blow pin 2 form an undercut 19 in the inside wall 13 of the container neck 11, which can have the form of an inside threading. In turn, the resqueezing section 25 of the calibrating blow pin 2 provides that plastic material is displaced from the lost hose section 18 into the container neck 11 during exclusively translatory running-in of the calibrating blow pin 2. A constriction created by the groove 15 in the outside wall of the container neck 11 at the transition from the container neck 11 to the container body 12 impedes the displacement of the plastic material from the container neck 11 into the container body 12. As a result, more plastic material is displaced from the lost section 18 into the container neck 11 than plastic material is displaced from the container neck 11 into the container body 12. As a result, a brief local compression of the plastic material occurs in the container neck 11, which compression can then expand again in the free spaces between the windings of the inside threading formed on the inside wall 13. In addition, an annular, at least partially circumferential shoulder 14 is created again at the transition from the container neck 11 to the container body 12.

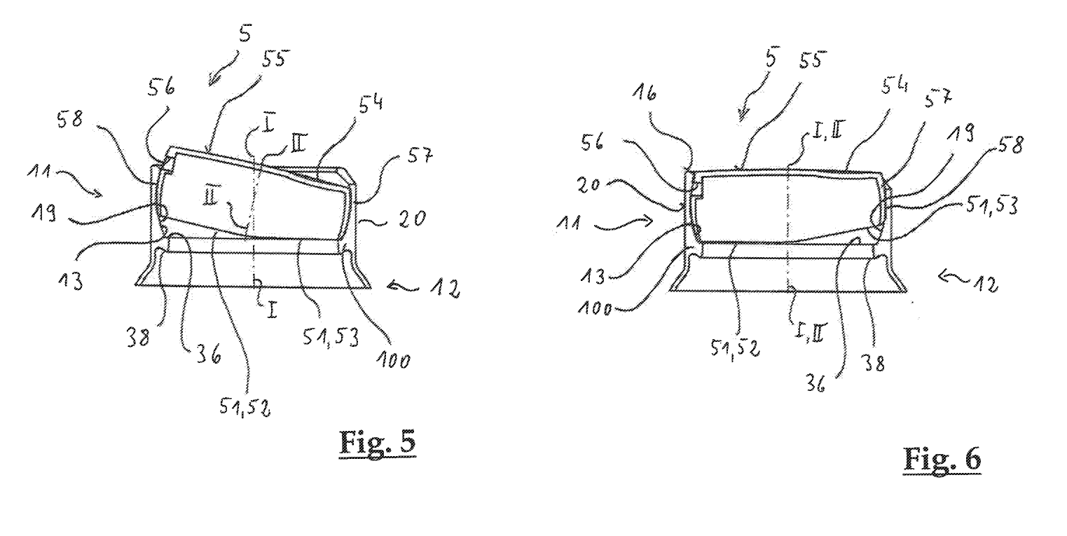

Similar to FIGS. 2 and 3, FIGS. 5 and 6 show a longitudinal section through the container neck 11 with the container body 12 that connects to the container neck 11 with one seal 5 each mounted in the container neck 11 in its respective end position. For the sake of clarity, hatching is not shown in the two figures. FIG. 5 shows the disk-like seal 5 in its open position. However, FIG. 6 shows the disk-like seal 5 in its closed position. In contrast to the embodiments according to FIGS. 2 and 3, the seating projections in the calibrated structuring and the lateral indentations in the seating surface 51 were not done in this embodiment.

Accordingly, the first seating section 52 that extends essentially parallel to the top surface 55 limits the second seating section 53, which extends obliquely inclined to the top surface 55. Between the top surface 55 and the seating surface 51, a seal side wall 57 extends in a circumferential manner, of which the outside wall 58 that faces the hollow-spherical undercut 19 is designed as a sphere. In this connection, the undercut 19 and the outside wall 58 of the seal side wall 57 correspond to one another. Also, the seal 5 in the seal side wall 57 can have a pour opening 56.

Opposite to the pour opening 56, a finger cavity 54 is formed in the top surface of the seal 5, which indicates to the user at which position of the seal pressure should be applied in order to move the seal 5 into the open position depicted in FIG. 5. In this connection, substance stored in the container body 12 can be removed through the pour opening 58. In this open position, a center axis II-II of the seal 5 is obliquely inclined relative to a center axis I-I of the container neck 11. In this open position, the second seating section 53 rests in a defined manner on the calibrated top 36 of an annular circumferential shoulder 14, formed from a material accumulation 100. The bottom 38, which is unstructured, lies opposite to the calibrated top 36 and faces the container body 12. The calibrated top 36 extends essentially crosswise to the center axis I-I of the container neck 11. The calibrated top 36 adjoins the calibrated structuring, formed in the inside wall 13 of the container neck 11, in the form of a hollow-spherical undercut 19. An outside wall 20 opposite to the inside wall 13 is shaped as a straight circular cylinder, which owing to the plastic excess, which ultimately forms the material accumulation 100 and thus the circumferential annular shoulder 14, is without shrink marks and does not correspond to a contour of the inside wall 13. The groove between the container neck 11 and the container body 12, depicted in FIG. 1, was eliminated in the two existing embodiments.

FIG. 6 shows the arrangement of FIG. 5 in the closed position. In this connection, the first seating section 52 rests in a predetermined manner on the top 36 of the circumferential annular shoulder 14. In this position, the pour opening 36 is closed by the calibrated structuring in the form of a hollow-spherical undercut 19. In this position, the calibrated structuring in the form of a hollow-spherical undercut 19 and the spherical seal side wall 57 can interact in such a way that no substance stored in the container body 12 can pass into the environment. In the closed position, the top surface 55 of the seal 5 and the neck edge 16 are flush with one another in this embodiment. Also, the center axis I-I of the container neck 11 and the center axis II-II of the seal 5 coincide.

Based on FIG. 1 and FIG. 4, the creation of a calibrated structuring 19 of the inside wall 13 of the container neck 11 was explained, which neck can be designed as a single large-area circumferential undercut with a contour like a spherical surface or a torus surface (FIG. 1) or is formed by an inside threading in the inside wall 13 (FIG. 4). In other exemplary embodiments of the disclosure, one or more calibrated structuring can be designed in the form of one or more receiving grooves for a bayonet closure. In addition, the calibrated structuring can also be designed as one or more receiving devices, distributed over the periphery, for one or more snap beads. This allows, for example, the mounting of a known, multi-part tip seal, which, however, unlike the state of the art, can be arranged in an invisible manner in the interior of the container neck.

In a method for the production of a plastic container according to an exemplary embodiment of the disclosure with a container neck that is designed according to the disclosure, in a first process step, a section of a single-layer or multi-layer plastic hose, extruded continuously or intermittently by an extrusion head, is introduced into a mold cavity of a blow mold tool. In a second process step, the hose section that is located in the mold cavity is inflated and cooled by a calibrating blow pin that is run into the hose through an opening in the blow mold tool by a gas that is injected with overpressure in the shape of the mold cavity to form the plastic container. In this case, a section of the plastic hose that corresponds to the container neck is calibrated. When the second process step is executed, when the calibrating blow pin is run into the hose section, plastic material is displaced from a lost section, upstream from the container neck that is created, of the plastic hose in the container neck. At least one calibrated structuring, whose shape is determined by an outside contour of a calibrating section of the calibrating blow pin, is formed in or on an inside wall of the container neck by the run-in calibrating blow pin. The calibrated structuring can be designed as an undercut, which recedes by a predetermined amount relative to the inside wall, or as a projection, which projects by a predetermined amount relative to the inside wall of the container neck. In a third process step, the finish-formed plastic container is ultimately demolded.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An extrusion-blow-molded plastic container, comprising:
a container body closed with a container bottom, and
a container neck connected to the container body, the container neck having a pour opening, wherein an inside wall of the container neck includes at least one calibrated structuring extending over a periphery of the inside wall at least in places, wherein the calibrated structuring is limited in a direction of the container body by a material accumulation, the material accumulation being shaped as a collar that extends at least partially along the periphery of the inside wall and crosswise to a center axis of the container neck.

2. The extrusion-blow-molded plastic container according to claim 1, wherein the collar is formed from a plastic material that is displaced from a lost hose section that connects to the pour opening.

3. The extrusion-blow-molded plastic container according to claim 1, wherein a top of the collar facing the pour opening is a calibrated collar.

4. The extrusion-blow-molded plastic container according to claim 1, wherein an outside wall, which is opposite to the inside wall having at least one calibrated structuring, has a contour that deviates from a contour of the inside wall.

5. The extrusion-blow-molded plastic container according to claim 4, wherein the outside wall is unstructured.

6. The extrusion-blow-molded plastic container according to claim 1, wherein the calibrated structuring, relative to an unstructured course of the inside wall, has a radial height or depth greater than or equal to 0.25 mm.

7. The extrusion-blow-molded plastic container according to claim 6, wherein the calibrated structuring, relative to an unstructured course of the inside wall, has a radial height or depth that is greater than 0.5 mm.

8. The extrusion-blow-molded plastic container according to claim 1, wherein the calibrated structuring has a contour that corresponds to a section of a torus surface.

9. The extrusion-blow-molded plastic container according to claim 1, wherein the calibrated structuring has a contour that corresponds to a section of a spherical surface.

10. The extrusion-blow-molded plastic container according to claim 1, wherein the calibrated structuring of the inside wall of the container neck is a single, annular circumferential undercut, which extends over ⅗ to 8/9 of an axial length of the container neck.

11. The extrusion-blow-molded plastic container according to claim 9, wherein the extension of the collar by the structured calibration crosswise to the center axis of the container neck is 0.5 mm to 2.5 mm.

12. The extrusion-blow-molded plastic container according to claim 3, wherein the top of the collar forms a seating surface, whereby the seating surface and the center axis of the container neck encompass an acute angle.

13. The extrusion-blow-molded plastic container according to claim 1, comprising:
at least one undercut in the inside wall of the container neck configured as at least one receiving groove for a bayonet closure.

14. The extrusion-blow-molded plastic container according to claim 13, comprising:
two or more receiving grooves, distributed over the periphery of the inside wall of the container neck, configured for a bayonet closure.

15. The extrusion-blow-molded plastic container according to claim 1, comprising:
at least one undercut in the inside wall of the container neck configured as an inside threading.

16. The extrusion-blow-molded plastic container according to claim 1, comprising:
a groove that is circumferential at least in places arranged at a transition from the container neck into the container body in an outside wall of the container neck.

17. A method for the production of a plastic container having a container body closed with a container bottom, and a container neck connected to the container body, the container neck having a pour opening, wherein an inside wall of the container neck includes at least one calibrated structuring extending over a periphery of the inside wall at least in places, wherein the calibrated structuring is limited in a direction of the container body by a material accumulation, the material accumulation being shaped as a collar that extends at least partially along the periphery of the inside wall and crosswise to a center axis of the container neck, the method comprising:
extruding continuously or intermittently by an extrusion head in an extrusion-blow-molding method, a section of a single-layer or multi-layer plastic hose;
introducing the section of a single-layer or multi-layer plastic hose into a mold cavity of a blow mold tool;
inflating and cooling the section of the single-layer or multi-layer plastic hose by introducing via a calibrating blow pin that is run into the hose through an opening in the blow mold tool, a gas that is injected with overpressure into the mold cavity to form the plastic container, wherein when the calibrating blow pin is run in, plastic material is displaced from a lost section of the plastic hose, upstream from the container neck through the pour opening in the container neck, and in the inside wall of the container neck, the at least one calibrated structuring is designed in the shape of an outside contour of a calibrating section of the calibrating blow pin;
forming the material accumulation that limits the calibrated structuring in the direction of the container body from the plastic material;
calibrating a section of the plastic hose that corresponds to the container neck; and
demolding the plastic container.

18. The method according to claim 17, comprising:
calibrating a top of the collar that faces the pour opening, wherein a bottom of the collar that faces away from the pour opening is unstructured.

19. The method according to claim 17, wherein a contour of the inside wall and a contour of an outside wall that is opposite to the inside wall do not correspond to one another.

20. The method according to claim 17, comprising:
forming a groove that is circumferential at least in places at a transition from the container neck to the container body in an outside wall of the plastic container.
